(19) United States
(12) Patent Application Publication
(10) Pub. No.: US 2010/0042477 A1
(43) Pub. Date: Feb. 18, 2010

(54) AUTOMATED DECISION SUPPORT FOR PRICING ENTERTAINMENT TICKETS

(76) Inventors: David Cavander, Los Angeles, CA (US); Wes Nichols, Los Angeles, CA (US); Jon Vein, Los Angeles, CA (US); Dominique Hanssens, Los Angeles, CA (US); Bret Leece, Los Angeles, CA (US); Douglas Rae, Los Angeles, CA (US); Jack Yang, Los Angeles, CA (US)

Correspondence Address: PERKINS COIE LLP, POST OFFICE BOX 1208, SEATTLE, WA, 98111-1208, US

(21) Appl. No.: 12/542,516

(22) Filed: Aug. 17, 2009

Related U.S. Application Data
(60) Provisional application No. 61/089,463, filed on Aug. 15, 2008.
(60) Provisional application No. 61/095,280, filed on Sep. 8, 2008.
(60) Provisional application No. 61/095,598, filed on Sep. 9, 2008.

(51) Int. Cl. G06Q 10/00; G06F 17/00; G06Q 50/00; G06N 5/02; G06Q 30/00

(52) U.S. Cl. 705/10; 235/375; 706/52

(57) ABSTRACT

A facility for automatically determining a recommended price for an entertainment event ticket is described. The facility determines a first group of attributes of the entertainment event ticket. For each of a second group of attributes selected from the determined first group of attributes, the facility applies to the attribute a lift factor determined for the attribute to obtain a quantitative measure of the effect of the attribute. The facility then combines the obtained quantitative measures of attribute effects to obtain a recommended price for the entertainment event ticket.

### CROSS-REFERENCE TO RELATED APPLICATION(S)

The present application claims the benefit of the following U.S. provisional applications, each of which is hereby incorporated by reference in its entirety: U.S. Provisional Patent Application No. 61/089,463, filed on Aug. 15, 2008, U.S. Provisional Patent Application No. 61/095,280, filed on Sep. 8, 2008, and U.S. Provisional Patent Application No. 61/095,598, filed on Sep. 9, 2008.

The present application is related to the following applications, each of which is hereby incorporated by reference in its entirety: U.S. Provisional Patent Application No. 60/895,729, filed Mar. 19, 2007, U.S. Provisional Patent Application No. 60/991,147, filed Nov. 29, 2007, U.S. Provisional Patent Application No. 61/084,252, filed Jul. 28, 2008, and U.S. Provisional Patent Application No. 61/084,255, filed Jul. 28, 2008.

### TECHNICAL FIELD

The described technology is directed to the field of automated decision support tools.

### BACKGROUND

It is common to sell tickets to entertainment events such as concerts, plays, and sporting events that each permit a person to attend the entertainment event. An entertainment event ticket is generally specific to a particular date and time, a particular place, and particular subject matter, such as a particular musical artist, play, or group of competing teams. Some entertainment tickets are further specific to a particular seat or seating section.

It is typical for entertainment event tickets to initially be sold by an event promoter through a ticket outlet. It is common for the event promoter to price tickets for an event at a small number of different price points, based upon the desirability of the corresponding seats receiving sections. Those who buy tickets for an event from its promoter may go on to resell their tickets. These resellers each set a price that they are willing to accept for their tickets. In some cases, resellers using online secondary ticket marketplace to list their tickets—i.e., notify others of the availability of their tickets—and, in some cases, to consummate a sale of their tickets.

### BRIEF DESCRIPTION OF THE DRAWINGS

FIG. 1 is a high-level data flow diagram showing data flow within a typical arrangement of components used to provide the facility.

FIG. 2 is a block diagram showing some of the components typically incorporated in at least some of the computer systems and other devices on which the facility executes.

FIGS. 3 and 4 are flow diagrams showing a process employed by the facility in some embodiments to maintain and employ ticket sales models, such as a model that projects the optimal price for a certain group of tickets, and/or a model that determines a probability of selling a certain group of tickets if priced at a particular level.

FIGS. 5 and 6 are display diagrams showing sample displays presented by an online ticket resale marketplace in connection with the facility in some embodiments.

### DETAILED DESCRIPTION

The inventors have recognized that little guidance is available to both (a) sellers of entertainment tickets about appropriate prices to set for their tickets, and (b) buyers of entertainment tickets about appropriate prices to pay for tickets. Accordingly, a tool that automatically provides pricing guidance for entertainment tickets would have significant utility.

A software facility that performs econometric analysis of entertainment ticket pricing (the “facility”)—e.g., concerts, plays, sporting events, etc.—(“the facility”) is described. In some embodiments, the facility predicts the likelihood that a ticket for a particular seat for a particular performance will be sold on a particular day if priced at a particular price. In some embodiments, the facility uses this information to assist individual resellers on a secondary market in pricing their tickets reasonably. In some embodiments, the facility determines a price at which a ticket for a particular seat (or a seat among a group of seats) for a particular performance should be listed for sale on a particular day that optimizes either price paid or overall likelihood of sale. In some embodiments, the facility uses this information to assist an issuer or volume reseller of such tickets in optimizing its pricing of these tickets.

In some embodiments, the facility provides additional information to ticket buyers in a ticket marketplace, such as: scoring each ticket listed for sale based upon the relationship of its listing price to a market-clearing price determined by the facility; identifying a ticket listed for sale for a particular event whose listing price is the furthest below (or the least above) its market-clearing price, e.g., identifying it as “the best value;” identifying among tickets listed for sale for a particular event the one determined by the facility to have the highest probability of selling, e.g., identifying it as “the hottest ticket.” In some embodiments, the facility assists ticket sellers in competing for designations such as the foregoing, such as by permitting a ticket seller to register to receive an alert when one of these designations is lost, e.g. via e-mail or text message. In some embodiments, the facility permits a ticket seller to establish rules according to which the seller's listing can be dynamically repriced by the facility. For example, a user may establish rules that specify a deadline for completing a sale, or a minimum price to accept, and permit the facility to periodically or continuously optimize the listing price subject to those constraints.

In some embodiments, the facility uses its analysis of the ticketing marketplace to predict the total number of tickets that will eventually be purchased and/or used to attend an event, and/or the timing of ticket sales for the event. This information may be sold to third parties, such as those who sell complementary offerings, or supplementary offerings. For example, a seller of complementary offerings, such as a seller of nearby lodgings, restaurants, or transportation resources, may use such information to contemporaneously market their complementary offerings to people who purchase tickets to the event. A seller of supplementary offerings may similarly use such information to target marketing of their offerings, such as by steering their marketing efforts to instances of the supplementary offerings that do not compete based upon date and/or location with events whose tickets are projected to be heavily subscribed.

In some embodiments, the facility uses a specialized database of elasticities for variables observed to drive the ticketing process (“ticketing drivers”) that is based upon historical sales results produced by known values of these driver variables. In some embodiments, elasticities for these ticketing drivers are adjusted, or only relevant subsets of elasticity observations are used, in accordance with details of the ticketing offering to be analyzed. The facility performs a goal-driven optimization using these tailored elasticities, in some cases applying ticketing-specific business rules.

In some embodiments, the analysis performed by the facility incorporates momentum information relevant to the ticketing offering, such as momentum information obtained from an Internet search engine (e.g., GoogleTrends), social networking website (e.g., FacebookLexicon), or other similar sources of information reflecting and up-to-the-minute measure of interest in the ticketing offering. In various embodiments, the analysis performed by the facility incorporates various kinds of other leading indicators of ticket sales as driver variables, such as previous touring history information; album sale information; information about digital music downloads (e.g., from BigChampagne); and surveys of knowledgeable populations such as employees of companies providing ticket marketplaces, entertainment critics, etc.

In some embodiments, the facility considers data received from one or more of a number of types of external sources, including the following: syndicated media, syndicated sales data, internet media, internet behavioral data, natural search query data, paid search activity data, media data like television, radio, print, consumer behavioral data, tracking survey data, economic data, weather data, financial data like stock market, competitive marketing spend data, and online and offline sales data.

In some embodiments, the facility retrieves outcome and driver data from each of a number of third-party sources, using a predefined template for each source to guide the retrieval and mapping of this third-party data. In some embodiments, the facility uses the retrieved third-party data together with client-specific data about sales or one or more other business outcomes that is obtained from the client in order to generate recommended resource allocations for the client. In some cases, this can obviate the need to collect outcome and/or driver data from the client, often saving significant time and resources.

In this manner, the facility assists sellers and/or buyers to productively participate in the market for entertainment tickets.

Ticket prices are the mechanism that equilibrates demand and supply. Demand is reflected in web traffic on the website of a secondary ticket marketplace for a particular performance. Web traffic is a function of the various drivers listed above plus marketing. The secondary ticket marketplace's marketing, including online paid search and newsletters and offline press, radio, outdoor, and TV, operate to drive additional web traffic.

Ticket supply may come from brokers, professional sellers, and the general public. Supply from the first two sources depends on allocations among promoters, venues, and sellers and is treated as fixed. Supply from the general public results from reselling and exhibits a low level of price responsiveness.

Treating supply as mostly fixed, the facility uses the price elasticity of demand to find the marginal and average ticket prices that clear the market for a given event or tour after factoring in the secondary ticket marketplace's marketing investments.

The sales or market response curves determined by the facility predict business outcomes as mathematical functions of various resource drivers:

Sales=F(Any Set of Driver Variables),

where F denotes a statistical function with the proper economic characteristics of diminishing returns

Further, since this relationship is based on data, either time series, cross-section, or both time series and cross-section, the method inherently yields direct, indirect, and interaction effects for the underlying conditions.

These effects describe how sales responds to changes in the underlying driver variables and data structures. Often, these response effects are known as “lift factors.” As a special subset or case, these methods allow reading any on-off condition for the cross-sections or time-series.

There are various classes of statistical functions which are appropriate for determining and applying different types of lift factors. In some embodiments, the facility uses a class known as multiplicative and log log (using natural logarithms) and point estimates of the lift factors.

In certain situations, the facility uses methods which apply to categorical driver data and categorical outcomes. These include the, classes of probabilistic lift factors known as multinomial logit, logit, probit, non-parametric or hazard methods.

In various embodiments, the facility uses a variety of other types of lift factors determined in a variety of ways. Statements about “elasticity” herein in many cases extend to lift factors of a variety of other types.

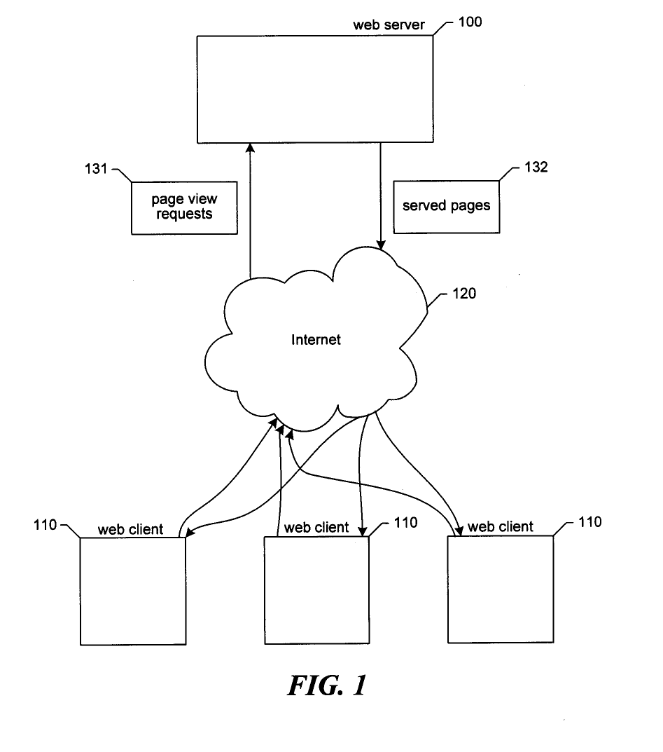

FIG. 1 is a high-level data flow diagram showing data flow within a typical arrangement of components used to provide the facility. A number of web client computer systems 110 that are under user control generate and send page view requests 131 to a logical web server 100 via a network such as the Internet 120. These requests typically include page view requests and other requests of various types relating to receiving information about a subject offering and providing information about prescribed total marketing budget and its distribution. Within the web server, these requests may either all be routed to a single web server computer system, or may be loaded-balanced among a number of web server computer systems. The web server typically replies to each with a served page 132.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different client devices may be used in place of the web client computer systems, such as mobile phones, personal digital assistants, televisions, cameras, etc.

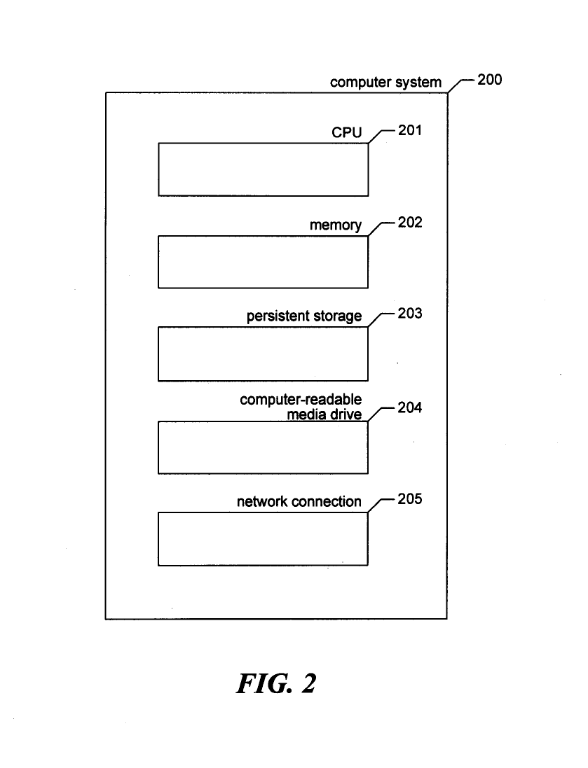

FIG. 2 is a block diagram showing some of the components typically incorporated in at least some of the computer systems and other devices on which the facility executes. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are typically used to support the operation of the facility, those skilled in the art will appreciate that the facility may be implemented using devices of various types and configurations, and having various components.

The inventors have identified the meta drivers shown below in Table 1 as affecting ticket prices and their elasticities:

TABLE 1

| | |
|---|---|
| 1) | Event type (parentID): Concerts, Sports, Theatre |
| 2) | Event characteristics |

| | |
|---|---|
| a. | Artist/event: e.g., Stevie Wonder concert, Six Nations Rugby |
| | Match, Joseph and Technicolour Dreamcoat |

| | |
|---|---|
| i. | External buzz, reflected in online search |
| ii. | Recent reviews |
| iii. | Teams/records |
| iv. | Time since last toured in UK |

| | |
|---|---|
| b. | Number of performances announced |
| c. | Number of cities |
| d. | Number of venues |
| e. | Time period of tour (months) |

| | |
|---|---|
| 3) | Venue characteristics |

| | |
|---|---|
| a. | Country |
| b. | City |
| c. | Venue Name |

| | |
|---|---|
| 4) | Performance characteristics |

| | |
|---|---|
| a. | Day of week |
| b. | Time of day |

| | |
|---|---|
| 5) | Seat Location |

| | |
|---|---|
| a. | Level |
| b. | Block |
| c. | Row |
| d. | Seat |

| | |
|---|---|
| 6) | Timing |

| | |
|---|---|
| a. | Days since on sale date |
| b. | Days until performance |

Accordingly, in some embodiments, the facility establishes and maintains a library of ticket price elasticities that varies based upon a combination of some or all of the drivers identified above.

In some embodiments, the facility uses demand modeling specifications to estimate the price elasticity of ticket demand in a secondary ticket market. In some embodiments, the model is in the form:

InS=f(InP, X), (1)

where:

S is quantity of tickets purchased

P is transaction price, and

X is a vector of other driver variables

The coefficient on the InP term represents the price elasticity of demand. In some embodiments, the facility determines these price elasticities for a wide variety of artists/events in three categories: Concerts, Sports, and Theatre and for specific venues, such as O2, Manchester ENR, and Wembley Stadium.

In some embodiments, the facility computes the probability of selling a ticket in a group of tickets in accordance with a formula such as the formula shown below in Equation (2):

$$probability = \frac{{e}^{Table 2 sum}}{1 + {e}^{Table 2 sum}} \qquad ( 2 )$$

In Equation (2), the term “Table 2 sum” refers to a quantity obtained from a set of independent variables—including a proposed selling price and values for driver variables—in accordance with Table 2 below. In particular, the value for the “Table 2 sum” term is obtained by first, for each of the 51 rows of Table 2, multiplying the value of the independent variable identified by the row by the coefficient identified by the row, then summing these 51 products.

TABLE 2
Independent Variables and Coefficients for Probability of Selling Group
of Tickets at O2 Arena in One Week

| | Independent | |
|---|---|---|
| Row | Variable | Coefficient |
| 1 | 1 | −0.97 |
| 2 | In_sellprc | −0.68 |
| 3 | d_weeks_to_per1 | 0.89 |
| 4 | d_weeks_to_per2 | 1.48 |
| 5 | d_weeks_to_per3 | 1.14 |
| 6 | d_weeks_to_per4 | 0.59 |
| 7 | d_weeks_to_per5 | 0.38 |
| 8 | d_weeks_to_per6 | 0.32 |
| 9 | d_tck1 | −2.38 |
| 10 | d_tck2 | −1.52 |
| 11 | d_tck34 | −1.47 |
| 12 | In_ticketsupply | −0.23 |
| 13 | In_pertrafficday | 0.83 |
| 14 | O2_Arna_A2 | 1.09 |
| 15 | O2_Arna_A1_A3 | 0.34 |
| 16 | O2_Arna_B2 | 0.54 |
| 17 | O2_Arna_B1_B3 | 0.27 |
| 18 | O2_Arna_C1_C3 | 0.54 |
| 19 | O2_level100 | 0.22 |
| 20 | O2_bstage | 0.5 |
| 21 | O2_Arna_Standing | 0.26 |
| 22 | Row_1 | 0.42 |
| 23 | Rows_2_5 | 0.01 |
| 24 | Rows_6_10 | 0.39 |
| 25 | d_wed | −0.04 |
| 26 | d_thu | −0.45 |
| 27 | d_fri | 0.11 |
| 28 | d_sat | 0.47 |
| 29 | d_sun | −0.23 |
| 30 | d_kylieminogue | 1.31 |
| 31 | d_rogerwaters | 0.76 |
| 32 | d_michaelbuble | 1.64 |
| 33 | d_duranduran | 0.9 |
| 34 | d_coldplay | 0.82 |
| 35 | d_eagles | 0.21 |
| 36 | d_queen_progers | 1.34 |
| 37 | d_stvwonder | 2.52 |
| 38 | d_celinedion | 0.72 |
| 39 | d_barrymanilow | 1.44 |
| 40 | d_tinaturner | 1.54 |
| 41 | d_aliciakeyes | −0.05 |
| 42 | d_chrisrock | −0.01 |
| 43 | d_neildiamond | 0.55 |
| 44 | d_mjblige | 0.42 |
| 45 | d_lencohen | 1.05 |
| 46 | d_nickelback | 0.16 |
| 47 | d_tiesto | −0.73 |
| 48 | d_boyzone | −0.35 |
| 49 | d_wwesmackdown | 0.81 |
| 50 | d_NBAEurope | 0.07 |
| 51 | d_boxMacHaye | −3.64 |

In some embodiments, the facility generates the coefficients shown in Table 2—described elsewhere herein as “establishing a model” for the arena—by applying a probit regression to data representing historical ticket sales, such as at the arena. In some embodiments, the facility does so using a proc logistic, such as by employing automated tools provided by SAS Institute Inc. of Cary, N.C., including SAS/STAT. In various embodiments, the facility employs various other model types and tools.

The rows of Table 2 have the following significance: The coefficient in row 1 is an intercept value that does not correspond to any particular independent variable. Row 2 represents the natural log of the proposed pro-ticket selling price.

Rows 3-8 represent “dummy” variables that relate to the amount of time remaining before the ticketed event: If less than one week remains before the event, the variable of row 3 takes on the value 1, while the variables of rows 4-8 take on the value 0; if between one and two weeks remain before the event, the variable of row for takes on the value 1, while the variables of rows three and 5-8 take on the value 0; etc.

Rows 9-11 represent dummy variables that relate to the number of tickets in a group of tickets to be sold: if the group of tickets contains only one ticket, the variable of row 9 takes on the value 1, while the variables of rows 10-11 take on the value 0; as a group of tickets contains two tickets, the variable of row 10 takes on the value number 1, while the variables of rows 9 and 11 take on the value 0; and if the group of tickets contains more than two tickets, the variable of row 11 takes on the value 1, while the variables of rows 9-10 take on the value 0.

Row 12 represents the natural log of the number of tickets available for the event. Row 13 represents the natural log of the volume of dynamic expression of interest in the event, such as dynamic Web browsing activity relating to the event.

Rows 14-21 represent dummy variables relating to the area of the venue in which the tickets are located, such as blocks or levels of formal seating in the venue (rows 14-19), backstage (row 20), and standing room (row 21). Rows 22-24 represent dummy variables relating to the row in which the tickets are located: if the tickets are located in row 1, the variable of row 22 takes on the value 1, while the variables of rows 23-24 take on the value 0; if the tickets are located in a row between 2 and 5, the variable of row 23 takes on the value 1, while the variables of rows 22 and 24 take on the value 0; if the tickets are located in a row between 6 and 10, the variable of row 24 takes a value 1, while the variables of rows 22-23 take on the value 0; and if the tickets are with seated in a row greater than 10, the variables of rows 22-24 whole take on the value 0.

Rows 25-29 represent dummy variables relating to the day of the week for which the event is scheduled. If the event is scheduled for Wednesday, the variable of row 25 takes on the value 1, while the variables of rows 26-29 takes on the value 0; etc. If the event is scheduled for Monday or Tuesday, the variables of all rows 25-29 take on the value 0.

Rows 30-51 represent dummy variables relating to the nature of the event: the variable corresponding to the artist, basketball league, boxing promoter, etc. featured in the event takes on the value 1, while the variables corresponding to the other rows among 30-51 take on the value 0.

Take the example of a single ticket to a Friday Stevie Wonder concert occurring in 10 days where the ticket is in row 5 of block B2, for which the proposed selling price is $500. Presently there are 100 tickets remaining, and an average of 900 web hits relating to the concert are occurring per day. For this example, the sum produced by Table 2 is 0.97*1+−0.68*In(500)+1.48*1+−2.38*1+−0.23*In(100)+0.83*In(900)+0.54*1+0.01*1+0.11*1+2.52*1 (i.e., non-zero values for the variables of rows 1, 2, 4, 9, 12, 13, 16, 23, 27, and 37), or 3.6109. For this sum, Equation (2) produces a probability of 97.37% of selling.

In some embodiments, the facility computes the optimal price for a ticket in accordance with a formula such as the formula shown below in Equation (3):

suggested price=e^{Table3sum} (3)

In Equation (3), the term “Table 3 sum” refers to quantity obtained from a set of independent variables—including values for driver variables—in accordance with Table 3 below. In particular, the value for “Table 3 sum” term is obtained by first, for each of the 63 rows of Table 3, multiplying the value of independent variable identified by the row by the coefficient identified by the row, then summing these 63 products.

TABLE 3
Independent Variables and Coefficients for Optimal Price for Ticket
at O2 Arena

| Row | IndependentVariable | Coefficient |
|---|---|---|
| 1 | 1 | 2.0972 |
| 2 | In_tsgfacevalue | 0.3784 |
| 3 | In_days_to_per | 0.1620 |
| 4 | In_TotalAvailable | −0.0980 |
| 5 | In_pertrafficday | 0.0372 |
| 6 | In_days_onsale | 0.0724 |
| 7 | bk_a2_interact | 0.8377 |
| 8 | bk_b2_interact | 0.0970 |
| 9 | bk_a1_a3_interact | 0.2882 |
| 10 | bk_b1_b3_interact | 0.1626 |
| 11 | bk_a2_interact_r2_5 | 0.2955 |
| 12 | bk_b2_interact_r2_5 | 0.1942 |
| 13 | bk_a1_a3_interact_r2_5 | 0.1995 |
| 14 | bk_b1_b3_interact_r2_5 | 0.0972 |
| 15 | Row_1_x | 0.1231 |
| 16 | Rows_2_5_x | 0.0430 |
| 17 | d_tue | −0.004385 |
| 18 | d_wed | 0.0306 |
| 19 | d_thu | 0.0827 |
| 20 | d_fri | 0.0560 |
| 21 | d_sat | 0.1189 |
| 22 | d_sun | 0.0571 |
| 23 | O2_Arna_101_112 | 0.3131 |
| 24 | O2_Arna_102_111 | 0.3633 |
| 25 | O2_Arna_103_110 | 0.2241 |
| 26 | O2_Arna_104_109 | 0.1617 |
| 27 | O2_Arna_105_108 | 0.1664 |
| 28 | O2_Arna_106_107 | 0.2780 |
| 29 | O2_Arna_113_118 | 0.3098 |
| 30 | O2_Arna_114_117 | 0.1359 |
| 31 | O2_Arna_115_116 | 0.2448 |
| 32 | O2_Arna_401_422 | −0.0418 |
| 33 | O2_Arna_402_421 | 0.0662 |
| 34 | O2_Arna_403_420 | 0.1052 |
| 35 | O2_Arna_404_419 | 0.0564 |
| 36 | O2_Arna_405_418 | 0.0388 |
| 37 | O2_Arna_407_416 | −0.0565 |
| 38 | O2_Arna_408_415 | −0.0203 |
| 39 | O2_Arna_409_414 | −0.0231 |
| 40 | O2_Arna_410_413 | 0.0353 |
| 41 | O2_Arna_411_412 | 0.1015 |
| 42 | O2_Arna_A1_A3 | 0.5375 |
| 43 | O2_Arna_A2 | 0.6471 |
| 44 | O2_Arna_B1_B3 | 0.3204 |
| 45 | O2_Arna_B2 | 0.3968 |
| 46 | O2_Arna_C1_C3 | 0.2418 |
| 47 | O2_Arna_D1_D3 | 0.4058 |
| 48 | d_kylieminogue | 0.0861 |
| 49 | d_rogerwaters | 0.2553 |
| 50 | d_michaelbuble | 0.1685 |
| 51 | d_jamesblunt | −0.2146 |
| 52 | d_coldplay | 0.4614 |
| 53 | d_eagles | 0.3277 |
| 54 | d_queen_progers | 0.3030 |
| 55 | d_stvwonder | 0.6501 |
| 56 | d_celinedion | 0.6051 |
| 57 | d_boyzone | −0.4565 |
| 58 | d_tinaturner | 0.4426 |
| 59 | d_aliciakeyes | 0.0592 |
| 60 | d_neildiamond | 0.3623 |
| 61 | d_boxMacHaye | 0.2526 |
| 62 | d_lencohen | 0.4098 |
| 63 | d_nickelback | 0.1932 |

In some embodiments, the facility generates the coefficients shown in Table 3—described elsewhere herein as “establishing a model” for the arena—by applying a probit regression to data representing historical ticket sales such as at the arena. In some embodiments, the facility does so using a proc logistic, such as by employing automated tools provided by SAS Institute Inc. of Cary, N.C., including SAS/STAT. In various embodiments, this facility employs various other model types and tools.

The rows of Table 3 have the following significance: the coefficient in row 1 is an intercept value that does not correspond to any particular independent variable. Row 2 represents the natural log of the face value of each of the tickets in the group.

Row 3 represents the natural log of the number of days until the event occurs. Row 4 represents the natural log of the number of tickets that remain available for the event. Row 5 represents the natural log of the volume of dynamic expression of interest in the event, such as dynamic Web browsing activity relating to the event. Row 6 represents the natural log of the number of days that tickets for the event have been on sale.

Rows 7-16 represent dummy variables that relate to the area within which the tickets are located, specifically the combination of blocks or levels of formal seating in the venue with rows within such blocks or levels. In particular, if the tickets are in the front row of block A2, the variable of row 7 takes on the value 1 and the variables of rows 8-16 take on value 0. If the tickets are in the front row of block B2, the variable of row 8 takes on the value 1 and the variables of rows seven and 9-16 take on the value 0. If the tickets are in the front row of block A1 or A3, the variable of row 9 takes on the value 1 and the variables of rows 7-8 and 10-16 take on the value 0. If the tickets are in the front row of block B1 or B3, the variable of row 10 takes on the value 1 and the variables of rows 7-9 and 11-16 take on the value 0. If the tickets are in rows 2-5 of block A2, the variable of row 11 takes on the value 1 and the variables of rows 7-10 and 12-16 take on value 0. If the tickets are in the rows 2-5 of block B2, the variable of row 12 takes on the value 1 and the variables of rows seven and 7-10 and 13-16 take on the value 0. If the tickets are in rows 2-5 of block A1 or A3, the variable of row 13 takes on the value 1 and the variables of rows 7-12 and 14-16 take on the value 0. If the tickets are in rows 2-5 of block B1 or B3, the variable of row 14 takes on the value 1 and the variables of rows 7-13 and 15-16 take on the value 0. If the tickets are in the front row of a block not among A1, A2, A3, B1, B2, and B3, the variable of Row 15 takes on the value 1, and the variables of rows 7-14 and 16 take on the value 0. If the tickets are in rows 2-5 of a block not among A1, A2, A3, B1, B2, and B3, the variable of row 16 takes on the value 1, and the variables of rows 7-15 take on the value 0. If the tickets are not in rows 1 -5, the variables of all rows 7-16 take on the value 0.

Row 17-22 represents dummy variables relating to the day of the week for which the event is scheduled. If The event is scheduled for Tuesday, the variable of row 17 takes on the value 1, while the variables of rows 18-20 to take on the value 0; etc. if the event is scheduled for Monday, the variables of all rows 25-29 take on the value 0.

Rows 23-47 represent dummy variables that relate to the area within which the tickets are located, specifically blocks or levels of formal seating in the venue. If the tickets are located in block 101 or 112, the variable of row 23 takes on the value 1 and the variables of rows 24-47 take on the value of 0. If the tickets are located in block 102 or 111, the variable of row 24 takes on the value 1 and the variables of rows 23 and 25-47 take on the value 0. If the tickets are located in block 103 or 110, the variable of row 25 takes on the value 1 and the variables of rows 23-24 and 26-47 take on the value 0. If the tickets are located in block 104 or 109, the variable of row 26 takes on the value 1 and the variables of rows 23-25 and 27-47 take on the value 0. If the tickets are located in block 105 or 108, the variable of row 27 takes on the value 1 and the variables of rows 23-26 and 28-47 take on the value 0. If the tickets are located in block 106 or 107, the variable of row 28 takes on the value 1 and the variables of rows 23-27 and 29-47 take on the value 0. If the tickets are located in block 113 or 118, the variable of row 29 takes on the value 1 and the variables of rows 23-28 and 30-47 take on the value 0. If the tickets are located in block 114 or 117, the variable of row 30 takes on the value 1 and the variables of rows 23-29 and 31-47 take on the value 0. If the tickets are located in block 115 or 116, the variable of row 31 takes on the value 1 and the variables of rows 23-30 and 31-47 take on the value 0. If the tickets are located in block 401 or 422, the variable of row 32 takes on the value 1 and the variables of rows 23-31 and 33-47 take on the value 0. If the tickets are located in block 402 or 421, the variable of row 33 takes on the value 1 and the variables of rows 23-32 and 34-47 take on the value 0. If the tickets are located in block 403 or 420, the variable of row 34 takes on the value 1 and the variables of rows 23-33 and 35-47 take on the value 0. If the tickets are located in block 404 or 419, the variable of row 35 takes on the value 1 and the variables of rows 23-34 and 36-47 take on the value 0. If the tickets are located in block 405 or 418, the variable of row 36 takes on the value 1 and the variables of rows 23-35 and 37-47 take on the value 0. If the tickets are located in block 407 or 416, the variable of row 37 takes on the value 1 and the variables of rows 23-36 and 38-47 take on the value 0. If the tickets are located in block 408 or 415, the variable of row 38 takes on the value 1 and the variables of rows 23-37 and 39-47 take on the value 0. If the tickets are located in block 409 or 414, the variable of row 39 takes on the value 1 and the variables of rows 23-38 and 40-47 take on the value 0. If the tickets are located in block 410 or 413, the variable of row 40 takes on the value 1 and the variables of rows 23-39 and 41-47 take on the value 0. If the tickets are located in block 411 or 412, the variable of row 41 takes on the value 1 and the variables of rows 23-40 and 42-47 take on the value 0. If the tickets are located in block A1 or A3, the variable of row 42 takes on the value 1 and the variables of rows 23-41 and 43-47 take on the value 0. If the tickets are located in block A2, the variable of row 43 takes on the value 1 and the variables of rows 23-42 and 44-47 take on the value 0. If the tickets are located in block B1 or B3, the variable of row 44 takes on the value 1 and the variables of rows 23-43 and 45-47 take on the value 0. If the tickets are located in block B2, the variable of row 45 takes on the value 1 and the variables of rows 23-44 and 46-47 take on the value 0. If the tickets are located in block Cl or C3, the variable of row 46 takes on the value 1 and the variables of rows 23-45 and 47-47 take on the value 0. If the tickets are located in block D1 or D3, the variable of row 47 takes on the value 1 and the variables of rows 23-46 take on the value 0. If the tickets are not located in any of the blocks enumerated above, the variables of all of rows 23-47 take on the value 0.

Rows 48-63 are dummy variables relating to the nature of the event: the variable corresponding to the artist, basketball league, boxing promoter, etc. featured in the event takes on the value 1, while the variables corresponding to the other rows among 40-63 takes on the value 0.

Take the example of a single ticket that has been on sale for 80 days to a Friday Stevie Wonder concert that will occur in 10 days where the ticket is in row 5 of block B2, for which the face value is $75. Presently there are 100 tickets remaining, and an average of 900 web hits relating to the concert are occurring per day. For this example, the sum produced by Table 3 is 2.0972*1+0.3784*In(75)+0.1620*In(10)+−0.0980*In(100)+0.0372*In(900)+0.0724*In(80)+0.1942*1+0.0560*1+0.3968*1+0.6501*1 (i.e., non-zero values for the variables of rows 1-6, 12, 20, 45, and 55), or 5.5201. For this sum, Equation (3) produces an optimal price of $249.66.

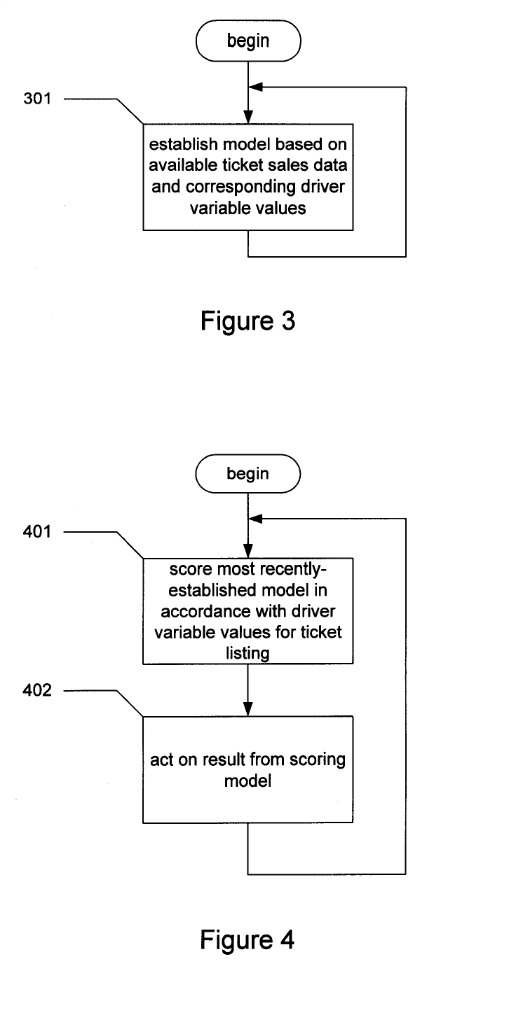

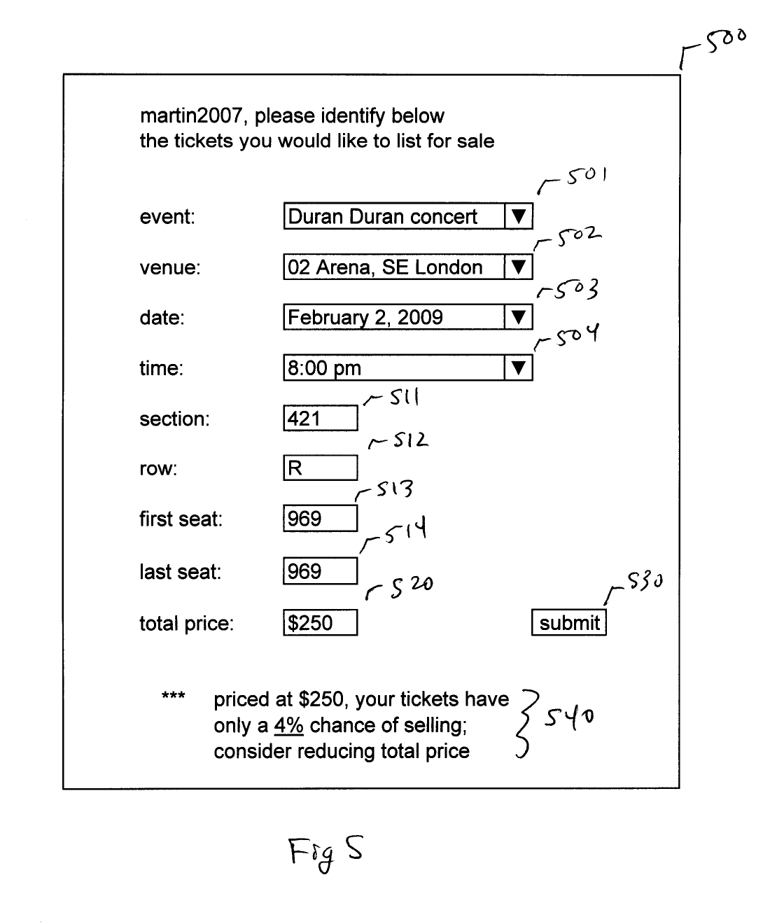

FIGS. 3 and 4 are flow diagrams showing a process employed by the facility in some embodiments to maintain and employ ticket sales models, such as a model that projects the optimal price for a certain group of tickets, and/or a model that determines a probability of selling a certain group of tickets if priced at a particular level. FIG. 3 is a flow diagram showing steps typically performed by the facility to maintain one or more ticket sales models. In step 301, the facility establishes a model based on available ticket sales data and the corresponding driver variable values. In some embodiments, the facility establishes a model as is discussed further below in connection with Tables 2 and 3. In some embodiments, the facility gathers the information that it uses to establish a model from one or more parties, including venue managers, event promoters, original ticket sellers, ticket resellers, Web publishers, and/or a variety of other kinds of sources. After step 301, the facility continues in step 301 establish a new model based upon new data. In various embodiments, step 301 is repeated at a variety of frequencies, such as yearly, quarterly, monthly, weekly, daily, hourly, etc.

Those skilled in the art will appreciate that the steps shown in FIG. 3 and in each of the flow diagrams discussed below may be altered in a variety of ways. For example, the order of the steps may be rearranged; substeps may be performed in parallel; shown steps may be omitted, or other steps may be included; etc.

FIG. 4 is a flow diagram showing steps typically perform other facility to exploit a model established in accordance with FIG. 3. In step 401, the facility scores the most recently-established model of the appropriate type in accordance with independent variable values that apply to a ticket listing of interest. In step 402, the facility acts on the result produced by scoring the model in step 401. Such action can take a variety of forms, including displaying the results or information based on the result; storing the result; selling the results of the data consumer; pricing event tickets in accordance with the result; creating, marketing, and social are pricing related goods and services based upon the result; etc. After step 402, the facility continues in step 401 to perform the next model-scoring cycle.

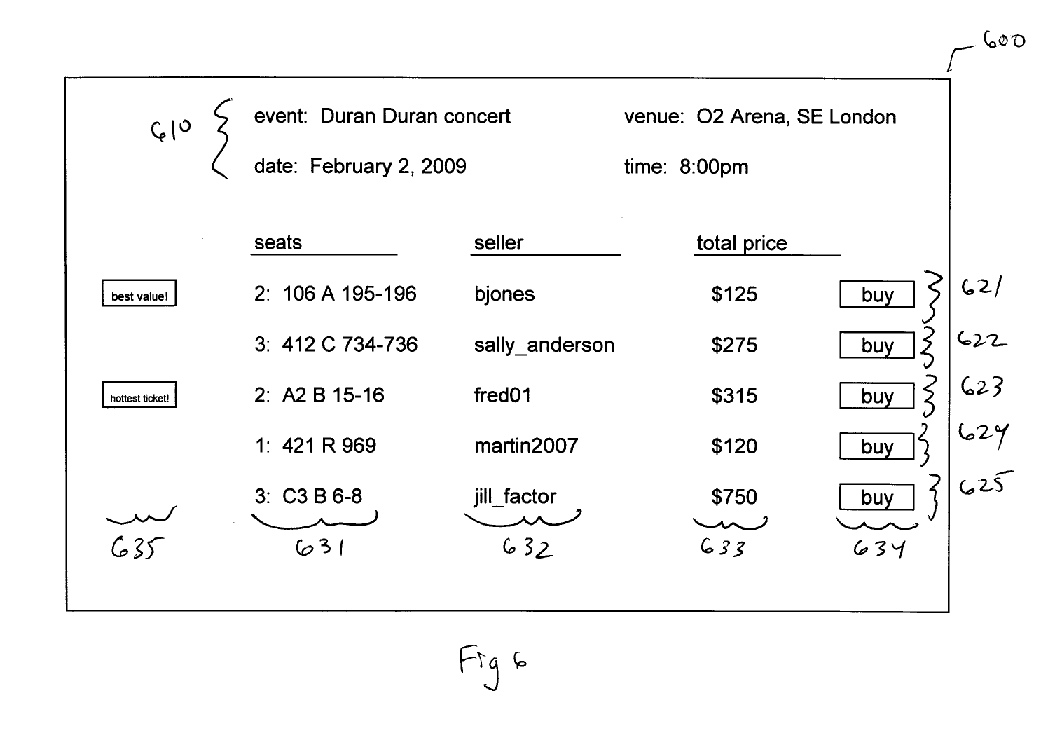

FIGS. 5 and 6 are display diagrams showing sample displays presented by an online ticket resale marketplace in connection with the facility in some embodiments. FIG. 5 is a display diagram showing a sample display presented to a user who is seeking to list a group of tickets for sale on the online ticket resale marketplace. The display 500 includes controls 501-504 that the user can use to identify the event that the tickets are for. The display further includes controls 511-514 that the user can use to identify the seats that the tickets are for. The display further includes a control 520 that the user can use to specify an asking price for the tickets. After the user has interacted with the controls to input this information, the users selects a submit control 530 to submit this ticket listing. In some embodiments, in response to submitting listing, the facility determines the likelihood that the tickets will be sold if the entered asking price is used. If the determined likelihood is below a configurable threshold, such as 25%, the facility causes a message such as message 540 to be displayed, warning the user of the low likelihood that the tickets will be sold at this price. At this point, the user can revise the entered asking price, or proceed to create the listing with the original asking price.

FIG. 6 is the display diagrams showing a sample display presented to a user who is seeking to purchase a group of tickets listed on the online ticket resale marketplace. The display 600 includes information 610 identifying an event for which tickets are available. Those skilled in the art will appreciate that a variety of navigation techniques may be made available to the user to discover the identified event, including searching, browsing, linking from pages relating specifically to the event, etc. The display contains a table of listings, such as listing 621-625. Each listing identifies the seats 631 that have been listed, the user 632 who is listed the tickets for sale, and the total price 633 sought by the seller. Each listing also has a buy control 634 that the user can select to purchase the tickets that are the subject of the listing. In some embodiments, the facility identifies certain listings with special designations 635. As examples, the “best value!” designation shown for listing 621 identifies this listing to have a listing price that is the furthest below or the least above its market-clearing price, while the “hottest ticket!” designation shown for listing 623 identifies this listing as to have the highest probability of selling.

It will be appreciated by those skilled in the art that the above-described facility may be straightforwardly adapted or extended in various ways.

We claim:

1. A computer-readable medium whose contents cause a computing system to perform a method for automatically determining a recommended price for an entertainment event ticket, the method comprising:
determining a first plurality of attributes of the entertainment event ticket;
for each of a second plurality of attributes selected from the determined first plurality of attributes, applying to the attribute a lift factor determined for the attribute to obtain a quantitative measure of the effect of the attribute; and
combining the obtained quantitative measures of attribute effects to obtain a recommended price for the entertainment event ticket.

2. The computer-readable medium of claim 1 wherein the applied lift factors are elasticities.

3. The computer-readable medium of claim 1, the method further comprising:
retrieving information about a ticket listing for the entertainment event ticket including a listing price;
comparing the retrieved listing price to the recommended price; and
based on the comparison, adding a visual designation to the ticket listing for displayed to users viewing the ticket listing that is based upon the results of the comparison.

4. The computer-readable medium of claim 1, the method further comprising:
retrieving information about a ticket listing for the entertainment event ticket including a listing price;
comparing the retrieved listing price to the recommended price.

5. The method of claim 1 wherein one of the second plurality of attributes is an indication of the level of recent online activity with respect to the distinguished event.

6. The method of claim 5 wherein the indication of the level of recent online activity with respect to the distinguished event is an indication of a number of people who have viewed listings for tickets to the distinguished entertainment event in an online secondary entertainment event ticket marketplace.

7. The method of claim 5 wherein the indication of the level of recent online activity with respect to the distinguished event is an indication of a number of people who have submitted an online search query relating to the distinguished entertainment event.

8. The method of claim 5 wherein the indication of the level of recent online activity with respect to the distinguished event is an indication of a number of people who have interacted with another person on a social networking site about the distinguished entertainment event.

9. The method of claim 5, further comprising:
projecting a future level of online activity with respect to the distinguished event; and
using the projected future level of online activity with respect to the distinguished event as one of the second pluralities of attributes.

10. The method of claim 9 wherein the projected level of online activity with respect to the distinguished event is a projection of a number of people who will view listings for tickets to the distinguished entertainment event in an online secondary entertainment event ticket marketplace.

11. A method in a computer system for automatically analyzing a proposed price for an entertainment event ticket, comprising:
determining a first plurality of attributes of the entertainment event ticket;
for each of a second plurality of attributes selected from the determined first plurality of attributes, applying to the attribute a lift factor determined for the attribute to obtain a quantitative measure of the effect of the attribute; and
combining the obtained quantitative measures of attribute effects with the proposed price for the entertainment event ticket to obtain a prediction of a likelihood that entertainment event ticket will be sold for the proposed price during a particular time period.

12. The method of claim 11 wherein one of the second plurality of attributes is an indication of the level of recent online activity with respect to the distinguished event.

13. The method of claim 12 wherein the indication of the level of recent online activity with respect to the distinguished event is an indication of a number of people who have viewed listings for tickets to the distinguished entertainment event in an online secondary entertainment event ticket marketplace.

14. The method of claim 12 wherein the indication of the level of recent online activity with respect to the distinguished event is an indication of a number of people who have submitted an online search query relating to the distinguished entertainment event.

15. The method of claim 12 wherein the indication of the level of recent online activity with respect to the distinguished event is an indication of a number of people who have interacted with another person on a social networking site about the distinguished entertainment event.

16. The method of claim 12, further comprising:
projecting a future level of online activity with respect to the distinguished event; and
using the projected future level of online activity with respect to the distinguished event as one of the second pluralities of attributes.

17. The method of claim 16 wherein the projected level of online activity with respect to the distinguished event is a projection of a number of people who will view listings for tickets to the distinguished entertainment event in an online secondary entertainment event ticket marketplace.

18. A method in a computer system for automatically analyzing proposed prices for entertainment event ticket for an event, comprising:
for each of a plurality of entertainment ticket listings each identifying an entertainment event ticket for the event:
determining a listing price specified by the entertainment ticket listing;
determining a first plurality of attributes of the entertainment event ticket;
for each of a second plurality of attributes selected from the determined first plurality of attributes, applying to the attribute a lift factor determined for the attribute to obtain a quantitative measure of the effect of the attribute; and
combining the obtained quantitative measures of attribute effects with the proposed price for the entertainment event ticket to obtain a prediction of a likelihood that entertainment event ticket will be sold for the proposed price during a particular time period; and
from the predicted likelihoods, projecting a number of tickets that will be sold for the event.

19. The method of claim 18, further comprising selling information identifying the projected number of tickets will be sold for the event to the seller of a good that is complementary to the event.

20. The method of claim 18, further comprising selling information identifying the projected number of tickets will be sold for the event to the seller of a good that is supplementary to the event.
